(19) United States
(12) Patent Application Publication
(10) Pub. No.: US 2015/0136376 A1
(43) Pub. Date: May 21, 2015

(54) METHOD AND DEVICE FOR DETERMINING AT LEAST ONE CONTROL SIGNAL FOR CONTROLLING AN AIR CONDITIONING SYSTEM

(71) Applicant: Hella KGaA Hueck & Co., Lippstadt (DE)

(72) Inventors: Thomas NIEMANN, Delmenhorst (DE); Ole Morisse, Bremen (DE)

(21) Appl. No.: 14/543,462

(22) Filed: Nov. 17, 2014

(30) Foreign Application Priority Data
Nov. 16, 2013 (DE) 102013019305.2

(51) Int. Cl. B60H 1/00

(52) U.S. Cl. CPC B60H 1/00742; B60H 1/0075; B60H 1/00785; B60H 1/008; B60H 1/00821; B60H 1/00878
USPC 165/202; 165/222

(57) ABSTRACT

A method for determining at least one control signal for controlling an air conditioning system for an interior space of a vehicle. Depending on measured state variables of the interior climate, an interior climate value is calculated from measurements of the interior temperature and from measurements of the interior air humidity by a signal-processing function. An air quality value describing the air quality is calculated from measurements of the percentage of volatile organic compounds in the internal atmosphere by a signal-processing function. A control signal for an air conditioning system is calculated from the interior climate value and the air quality value by at least one signal-processing function. Further, a device for performing the method as well as to a vehicle with the device.

### CROSS REFERENCE TO RELATED APPLICATION

This application claims priority of Application No. 10 2013 019 305.2 filed in Germany on Nov. 16, 2013 under 35 U.S.C. §119, the entire contents of all of which are hereby incorporated by reference.

### BACKGROUND OF THE INVENTION

1. Field of the Invention

The invention relates to a method for determining at least one control signal for controlling an air conditioning system for an interior space, in particular for an interior space of a vehicle, in dependence of measured state variables of the interior climate. Further the invention relates to a device for performing the method with at least one internal temperature sensor, at least one air humidity sensor and at least one air quality sensor for determining the percentage of volatile organic compounds in the internal atmosphere. In addition the invention relates to a vehicle, in particular a motor vehicle, with an above-described device.

2. Brief Description of the Related Art

Methods and devices for controlling an air-conditioning system are known and used in very many motor vehicles. Controlling a vehicle interior climate is made possible by monitoring various state variables of the interior climate. Sensors for detecting individual parameters describing the interior climate such as for detecting the interior temperature, interior air humidity, window surface temperature, solar radiation and air quality are known and are used in motor vehicles. The plurality of sensors installed in a motor vehicle for detecting the climate-describing parameters can lead to problems during installation of the electrics and during evaluation of the sensor-detected variables. The resulting expensive cable architectures and a great many required data nodes or computing devices lead to cost-intensive constructions.

A particular problem is the detection by sensor of the interior air quality. This is usually carried out using carbon dioxide sensors which record the percentage of carbon dioxide in the interior air by optical processes. Such optical sensors consume a lot of electricity, are cost-intensive and in addition prone to faults. One problem, above all, consists in that the optical carbon dioxide sensors may be rendered temporarily inoperable due to events in the internal atmosphere, during which e.g. a great many airborne particles may be set free.

### SUMMARY OF THE INVENTION

The invention is based on the requirement to propose a method with which a cost-effective and energy-efficient control of an air-conditioning system is made possible for an interior space of a vehicle.

With a method for controlling at least one control signal for controlling an air-conditioning system for an interior space, in particular an interior space of a vehicle, in dependence of measured state variables of the interior climate provision is made, according to the invention, for an interior climate value describing the interior climate to be calculated from the measurements of the interior temperature and the measurements of the interior air humidity with the aid of a signal-processing function, and for an air quality value describing the air quality to be calculated from measurements of the percentage of volatile compounds in the internal atmosphere with the aid a signal-processing function, and for a control signal for an air-conditioning system to be calculated from the interior climate value and the air quality value with the aid of at least one signal-processing function. Detection of the required measurements of the interior climate, the internal humidity and the percentage of volatile organic compounds in the internal atmosphere is effected, in many motor vehicles, by respective standard sensors. The measurement for the interior temperature and the internal humidity form the basis for calculating an interior climate value which for example may correspond to the comfort temperature of humans. By comfort temperature is understood the temperature or temperature range which humans generally perceive as pleasant. This variable is dependent on several state variables of the interior climate. Air humidity for example has a large influence on as to whether a temperature is perceived as pleasant or unpleasant. Furthermore calculation of the interior climate value may include pre-determined parameters, which describe the human comfort temperature range. The interior climate value is input into a signal-processing function, which outputs a control signal to the air-conditioning system. Apart from a temperature perceived as pleasant the air quality of the interior space of a vehicle is also of major importance to the comfort of the occupants. Calculation of an air quality value also includes the percentage of volatile organic compounds in the internal atmosphere. The air quality value is used as an input for calculating a control signal for the air-conditioning system in order to ensure good ventilation of the interior space. Volatile organic compounds in the interior space may e.g. include fuel vapours which may penetrate into the interior space during entry of exit or during venting, or also solvent vapours which may be given off by the internal lining of the motor vehicle. In addition organic compounds given off by humans may be included in the detection of volatile organic compounds.

In a further development of the method calculation of the interior climate value may include at least one measurement of solar radiation. In order to precisely detect the interior temperature, the solar radiation entering the interior space is also detected by sensor, in addition to the thermal radiation emanating from the interior space. By including the measurements of the solar radiation a more precise computer model of the interior temperature is made possible because it means that the heat from sun-lit elements of the interior space can also be included in the calculation. This makes it possible to more precisely estimate the interior temperature. Further the solar radiation entering the interior space has an influence upon how persons present in the interior space perceive the temperature. Solar radiation measurements may be input into the calculation of the interior climate value.

In an advantageous further development of the method the calculation of the air quality value includes at least one measurement describing the outside air and recorded by an outside air quality sensor. By detecting volatile organic compounds the interior air quality is monitored. If, for example the percentage of volatile organic compounds exceeds a threshold, a control signal may sent, for example, to a control device of an air conditioning system, in order to initiate appropriate measures. One measure for lowering the percentage of volatile organic compounds in the interior space is e.g. the ventilation using fresh air. However, this is only meaningful if the outside air is of a higher quality, i.e. if it comprises a lower percentage of volatile organic compounds than the internal air. In addition the outside air may be examined for its percentage of compounds occurring in vehicle exhaust gases such as nitrogen oxide, carbon dioxide or carbon monoxide. The state variables of the outside air are recorded by an outside air quality sensor for example in the area of the air suction inlet. The output values of the outside air quality sensor are input into the calculation of the air quality value and thus into the control signal which is sent to an air conditioning system.

In an advantageous further development of the method at least one interior climate value and at least one air quality value are input into the calculation of a comfort function, and predefined parameters describing the climatic comfort zone of humans are input into the comfort function, and at least one output value of the comfort function is input into a control signal which is forwarded to a control unit of an air conditioning system. The state variables of the interior climate, which have an influence on the climatic comfort of humans, are input into the calculation of the comfort function. The interior temperature, the interior air humidity and the solar radiation are input into the comfort function via the calculated interior climate value. The percentage of volatile organic compounds in the interior air and the quality of the outside air, e.g. the percentage of nitrogen oxides or carbon monoxide is input via the air quality value. The comfort function, after it has been calculated, outputs e.g. a comfort value describing the interior climate. The comfort value is input into a control signal for controlling an air conditioning system. For example, a threshold value may be specified which if it is exceeded, may be an indication that one or more state variables of the interior climate lie outside the comfort zone of humans. By controlling the air conditioning system the respective state variables can be regulated accordingly.

In a preferred embodiment of the method the air quality value and the interior climate value are input into an energy demand control model for minimising the energy demand of the air conditioning system, and at least one output value of the energy demand control model is input into a control signal which is forwarded to a control unit of an air conditioning system. One important aim in controlling an air conditioning system is an energy-efficient operation of the air conditioning system. A highly energy-intensive process, in which unused energy is additionally discharged, is the supply of fresh air into the interior space for a corresponding discharge of a part of the internal air. The energy loss is particularly high if a large temperature difference exists between interior air and outside air. In these cases the outside air needs to be warmed up or cooled down very considerably. In addition, once the fresh air has been supplied, it needs to be conditioned, a process which is expensive. For example, additional filters may be employed to filter out pollen, fine dust or other foreign particles. Heavily laden filters in particular may reduce the suction performance of the air conditioning system and thus contribute to an increased energy consumption. One possible measure for reducing the energy consumption of the air conditioning system consists in operating the air conditioning system in air circulation mode for most of its operating time. In air circulation mode the interior air in the interior space is recirculated. In this way the temperature of the interior air remains at approximately the same level. Excessive cooling or warming up of the air is not necessary. The problem with air circulation is that volatile organic compounds, including carbon dioxide or carbon monoxide accumulate in the internal air. This represents a safety risk, since in particular an increased percentage of carbon dioxide or carbon monoxide may reduce the driver's concentration. In addition, if the interior space is insufficiently ventilated, the air humidity value in the interior space rises, which in turn may impact the feeling of comfort of the occupants. Under certain circumstances a high air humidity value may even lead to water condensing on the windows of the interior space. Using an energy demand control model a calculation is performed to find out, when the supply of fresh air is most meaningful with regard to energy efficiency. To this end output values of the interior climate value and the air quality value are entered into the energy demand control model. For example the interior climate value and the air quality value are compared respectively with threshold values which, when they are exceeded, necessitate the supply of fresh air into the interior space. The output values of the energy demand control model are input into a control signal which is forwarded to a control unit of the air conditioning system.

In a particularly preferred further development of the method the output values of the comfort function and the output values of the energy demand control model are set into a relationship, and for certain relationships of the output values a control signal is sent to the control unit of the air conditioning system for ventilating the interior space. Since ventilation of the interior space leads to an increase in energy demand, it is advantageous to run the air conditioning system in circulation mode for most of its operating time. This leads to a conflict between the comfort perception of the occupants of the vehicle and the desire for an energy-efficient operation of the air conditioning system. Frequent venting of the interior space improves the perceived comfort, but leads to an increased energy consumption. Using the ratio between the output values of the comfort function and of the energy demand control model a decision may be made e.g. with the aid of a control routine, whether venting is necessary or not. This could be determined e.g. by manually setting a limit as from which output value ratio onwards venting shall be carried out. Therefore this setting could reflect whether the air conditioning system should be controlled leaning more towards energy efficiency or leaning more towards occupant comfort.

In a preferred further development of the method at least one temperature measurement at a surface in the interior space, in particular at an inner surface of a window pane, and at least one measurement of the interior air humidity are input into a signal-processing function for determining the condensation probability of water in the interior space, and the output values of the function are input into a control signal of an air conditioning system. Apart from setting the climatic state variables of the interior climate within the limits of the human comfort zone an air conditioning system also has functions relevant to driving safety. As such a misting up of windows in the interior space can be prevented by selectively regulating the relevant state variables of the air conditioning system. To this end measurements of the interior air humidity and measurements of the temperature at an internal window pane, e.g. at inner surfaces of the windscreen, are input into a function for determining the condensation probability of water. If for a certain air humidity the temperature at a window pane drops below the dew point temperature, part of the water contained in the air condenses at a window pane. Output values of the function for determining the condensation probability in the interior space are input into a control signal of the air conditioning system in order to counteract condensation by raising the temperature or reducing the air humidity through the supply of fresh air.

In an advantageous further development of the method at least one measurement of the interior temperature is input into the function for determining the condensation probability. Apart from the temperature at an inside window surface the interior temperature is also a decisive parameter for the probability of condensation occurring in the interior space. The interior temperature is detected by sensor and additionally is input into the function for determining the condensation probability.

In an advantageous further development of the method the measurements of the interior temperature are detected in spatial dependence, and these spatially dependent measurements are used to draw conclusions as to the location of persons in the interior space, in particular which seat they occupy. The interior temperature can, in particular, be detected by detecting the thermal radiation emanating from the interior. The persons present in the interior pay a large contribution towards warming up the interior. By adequately spatially resolving the thermal radiation emanating from the interior and thus also the thermal radiation emanating from the occupants it is possible to determine, whether e.g. a seat in a car is occupied by a person or not. Thus, by detecting the temperature, it is possible to determine the number of persons present inside the vehicle, in particular to determine on which seats they are sitting.

In a preferred embodiment of the method the number of persons present in the interior is input into a control signal which is forwarded to the control device of an air conditioning system. In order to achieve an energy-efficient operation of an air conditioning system, it is preferred to operate it in air circulation mode rather than in constant fresh air intake mode. Avoiding fresh air supply brings with it the danger that carbon dioxide might accumulate in the air of the interior. This represents a safety risk because carbon dioxide if exceeding certain limit values, may reduce the concentration of the vehicle occupants. To directly detect the carbon dioxide concentration in the interior air is possible only with cost-intensive optical carbon dioxide sensors. Moreover the measurements taken by carbon dioxide sensors are relatively unreliable since the optical measuring process may be influenced for example by other substances in the internal air. By determining the number of person present inside the vehicle it is possible, taking into account pre-set parameters, to predict the carbon dioxide content in the internal air. The pre-set parameters may be for example the carbon dioxide emission per person and time section. The theoretically determined carbon dioxide content may enter into a control signal which is forwarded to the control device of an air conditioning system. If a carbon dioxide limit value is exceeded by the calculated carbon dioxide percentage in the internal air, fresh air is supplied by the air conditioning system. Apart from the number of persons present inside the vehicle the detected percentage of volatile organic compounds contained in the interior air may enter into the calculation of the carbon dioxide value. Each person present inside the vehicle contributes to the percentage of organic compounds so that from the percentage of volatile organic compounds conclusions can be drawn as to the carbon dioxide concentration in the internal air. The percentage of volatile organic compounds in the interior air may therefore be an indicator for the carbon dioxide concentration.

In a further development of the method conclusions are drawn from the spatially dependent measurements of the interior temperature as to the size of a person sitting on a seat. Due to adequately spatially resolving the thermal radiation emanating from the interior and thus the thermal radiation emanating from the occupants it is possible, apart from determining which seats are occupied, to draw conclusions as to the size of a person occupying a seat. A large person, for example, comprises a spatial distribution of the emitted thermal radiation which is different from a small person. From the size of the person conclusions can be drawn as to further parameters such as the carbon dioxide emissions or the emission of volatile organic compounds of the person. These theoretically ascertained parameters may be entered into a control signal which is forwarded to the control device of an air conditioning system. By estimating the size of persons sitting on seats the model is considerably refined so that a more accurate control of air conditioning systems is ensured.

In a further development of the method the control of the fresh air supply into the interior is regulated by output values of the energy demand control model. Due to using the energy demand control model for controlling the fresh air supply the energy demand of the air conditioning system is considerably reduced. Preferably fresh air is supplied to the interior only if this is favourable with regard to energy efficiency. As long as the state variables of the interior climate will allow it, the air conditioning system is operated in air circulation mode.

A further aspect of the invention relates to a device for performing the method according to the invention, with at least one internal temperature sensor, at least one air humidity sensor and at least one air quality sensor for determining the percentage of volatile organic compounds in the internal atmosphere. With the device according to the invention provision is made for the sensors to be connected in a signal-transferring manner with a computer unit for calculating a control signal on the basis of the output values of the sensors and for the computer unit to be connected in a signal-transferring manner with at least one control unit of an air conditioning system. By using an internal temperature sensor, an air humidity sensor and an air quality sensor, all essential parameters describing the interior climate can be recorded. The different sensors are connected in a signal-transferring manner with a computer unit, preferably a central computer unit. The control signals calculated in this computer unit can be transmitted via a further signal-transferring connection to a control unit of an air conditioning system.

In an advantageous further development of the invention at least two sensors are installed in one assembly. The arrangement of several, preferably all sensors in one assembly and thus installed in one installation space, is preferable compared to the distribution of the sensors across the interior. In particular the use of an already existing sensor installation space such as the installation space of the rain-light-sensor in the upper area of the upper edge of the windscreen has the advantage that already existing sensors, data nodes and cable looms can be utilised for forwarding the signals. Additional sensors such as an air quality sensor for measuring the percentage of volatile organic compounds, or an internal temperature sensor can be added, grouped together as a module, to the rain-light-sensor. All sensors for recording the interior climate are thus united in one installation space. Or the respective modules may be integrated in the installation space of an already existing front camera system.

In a preferred embodiment of the invention the device comprises a temperature sensor for determining the temperature of a surface, in particular an inside window surface, of the interior. This temperature sensor may, for example, be arranged in the area of the rain-light-sensor and/or in the area of the front camera. By reading the temperature sensor a prediction may be made, in conjunction with measurements of the interior air humidity, of the condensation probability of water, for example on an inside window surface. The output values of the calculation of the condensation probability may be input into the control of the air conditioning system.

In an advantageous further development of the invention the device may comprise a signal-transferring connection to an outside air quality sensor. Preferably the outside air quality sensor is arranged externally to the interior space in the area of an air suction intake of the air conditioning system. The outside air quality sensor comprises a signal-transferring connection to a computer unit or an evaluation unit. It is for example possible with the aid of the outside air quality sensor to monitor the percentage of carbon dioxide or nitrogen oxides in the outside air.

In a further development of the invention the device comprises a solar radiation sensor. A solar radiation sensor may for example be arranged in the area of a front camera. The solar radiation sensor is arranged in such a way that the sun light entering the interior can be recorded in dependence of the angle of incidence. The measurements recorded by the solar radiation sensor are input into the control signal for controlling the air conditioning system in order to account for the heat development and also for the temperature perception of the occupants based on the solar radiation. In particular a determination can be made based on the angle-resolved measurements of the solar radiation sensor as to which area of the interior is warmed up by the solar radiation.

In a preferred embodiment of the invention at least one internal temperature sensor faces the interior space, in particular the seats, in a vehicle. Preferably all sensors are arranged in the area of e.g. a front camera and/or a rain-light-sensor. The temperature sensor for determining the temperature on an inside surface of a window pane as well as the solar radiation sensor may be facing e.g. the front windscreen. The sensors for determining the interior temperature, the interior air humidity and the interior air quality, i.e. the percentage of volatile organic compounds, may be facing the interior space. The internal temperature sensors record the interior temperature preferably in the form of thermal radiation which emanates from the interior space. The temperature sensors may be aligned such that each temperature sensor records the thermal radiation of a certain angle range. By evaluating the different angle ranges seat occupancy can be determined since occupants of the vehicle seats can be registered due to the heat they radiate. The spatial resolution of the temperature sensors in particular may be so high that it is possible to estimate the respective size of the persons occupying the seats. Based on the sizes of persons further parameters such as carbon dioxide emissions or the emission of volatile organic compounds can be more accurately estimated. This allows for a more precise control of air conditioning systems. In addition temperature sensors may be arranged in the assembly making up the dashboard surface in order to record the thermal radiation emitted by the dashboard.

In a preferred embodiment of the invention the internal temperature sensor comprises at least one thermopile. Thermopiles are electrical components which convert thermal energy into electrical energy. Thermopiles are mass articles and can thus be bought very cheaply. By arranging several thermopiles adjacent to each other in different angle alignments it is possible to record the thermal radiation of different spatial angles.

Moreover the invention relates to a vehicle, in particular a motor vehicle, with a device according to the invention. With a motor vehicle it is possible to use a plurality of already existing sensors for recording the different interior climate state variables.

All features mentioned in the above description and in the claims can be selectively combined with the features of the independent claim. The disclosure of the invention is thus not limited to the described or claimed feature combinations, rather all feature combinations which are meaningful in terms of the invention are considered as having been disclosed.

### BRIEF DESCRIPTION OF THE DRAWINGS

The invention will now be explained in detail by way of a preferred embodiment shown in the drawing, in which the following details are schematically shown:

FIG. 1 shows a schematic representation of the method;

FIG. 2 shows a schematic perspective partial view of a vehicle with a device for performing the method; and

FIG. 3 shows a schematic perspective partial view of a vehicle with a device according to FIG. 2.

### DETAILED DESCRIPTION OF THE PREFERRED EMBODIMENTS

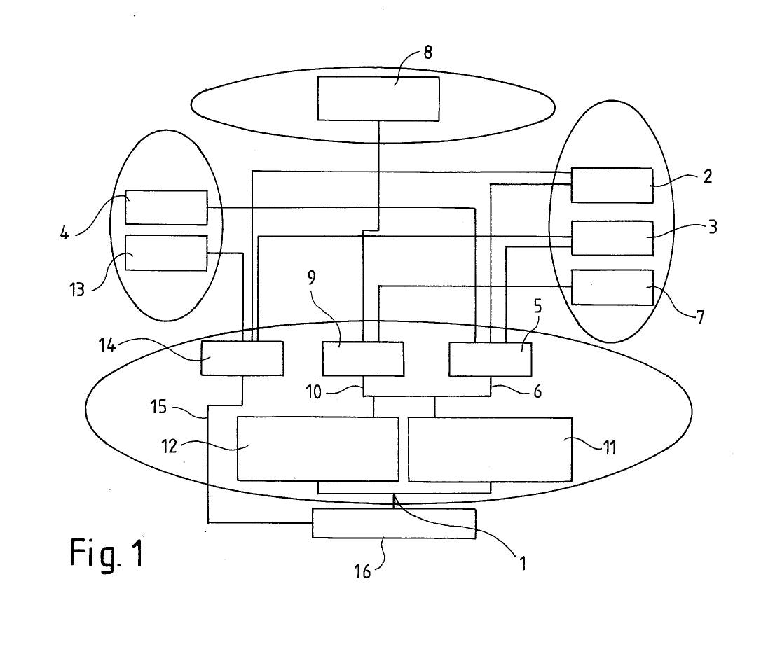

FIG. 1 schematically shows the progression of a method for determining at least one control signal 1 for controlling an air conditioning system. Measurements of the interior temperature 2, the interior air humidity 3 and the solar radiation 4 are input into a signal-processing function 5. Based on these measurements 2, 3, 4 an interior climate value 6 is calculated in the signal-processing function 5. Measurements of the percentage of volatile organic compounds 7 in the interior air and measurements of the outside air quality 8 are input into a signal-processing function 9, through which an air quality value 10 describing the air quality is calculated.

The measurements of the interior air humidity 3 and the interior temperature 2 represent central variables which influence the comfort zone of humans. A further measurement which depends on the comfort zone of humans is the solar radiation 4 entering the interior of the vehicle. These state variables are input into the calculation of the interior climate value 6 which may, for example be a human comfort temperature. In addition the air quality inside the vehicle is of great importance to the comfort perception for humans. An air quality value 10 is calculated from the percentage of volatile organic compounds 7, which, for example, may include solvent vapours, fuel traces or even secretions of the human body. In addition the percentage of volatile organic compounds in the interior air is an indicator for the amount of carbon dioxide. Therefore, using predefined parameters, a value for the percentage of carbon dioxide in the interior air may be estimated based on the calculation of the percentage of organic compounds. There is therefore no need to detect the carbon dioxide by optical sensors. Moreover measurements of the outside air quality 8, which are recorded in the area of the fresh air intake of the air conditioning system, are input into the air quality value 10.

Interior climate values 6 and air quality values 10 are input, together with specified parameters describing the climatic comfort zone of humans, into a function 11 for describing the comfort inside the vehicle. The output values of this comfort function 11 are input into a control signal 1, which is forwarded to a control unit of an air conditioning system. Apart from the comfort function 11 an energy demand control model 12 for minimising the energy demand of the air conditioning system is calculated from the interior climate values 6 and the air quality values 10. The largest energy losses in the climate control of a vehicle occur when fresh air is introduced. The reason for this is that fresh air has to be cooled or heated to the desired temperature and that the fresh air has to be treated by a filtering process. In order to avoid this, an air conditioning system is run in air circulation mode for as long as possible. Using the energy demand control model 12 the fresh air supplied into the interior space is controlled in such a way that energy losses are reduced to a minimum.

Temperature measurements 13 at a surface inside the vehicle, e.g. the windscreen, of the interior temperature 2 and the interior air humidity 3 are input into a function 14 for calculating the condensation probability of water inside the vehicle. If the temperature at the windscreen, for a certain air humidity, drops below the dew point temperature, water is likely to condensate on the inside of the windscreen. Output values 15 of this function 14 are forwarded to the control device 16 of the air conditioning system. If the probability of condensation is high the interior temperature can be controlled accordingly and/or the air humidity can be lowered by drawing in fresh air.

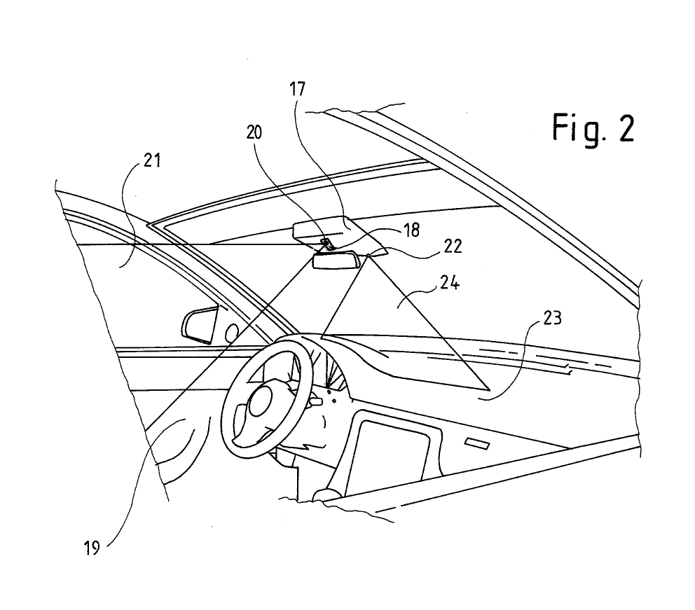

FIG. 2 shows a device for performing the method according to the invention. The individual sensors required for recording the individual state variables describing the interior climate are arranged in an installation space 17 associated with the rain-light-sensor. This installation space may be arranged in the area of a front camera. The already existing individual sensors and the associated data nodes and corresponding cabling may be made use of The air quality sensor 18 for determining the percentage of volatile organic compounds in the interior air faces the passenger compartment 19. Recording of the interior temperature is effected via an internal temperature sensor 20, which in particular is configured as an array of thermopiles, where thermopiles are facing the interior space 19 of the vehicle at different angles. By varying the orientation of the thermopiles the thermal radiation 21 emanating from the interior space 19 can be recorded in dependence of the location. Because the measurements are location-dependent, it is possible to recognise whether a seat in the interior space 19 is occupied by a person, or not. Further one thermopile 22 of the surface 23 faces the dashboard in order to record the thermal radiation 24 emanating from the dashboard. Due to the increased solar radiation in this area and due to the normally dark colouring of the dashboard the thermal radiation 24 radiated back from the dashboard 23 considerably contributes to the warming up of the vehicle interior 19.

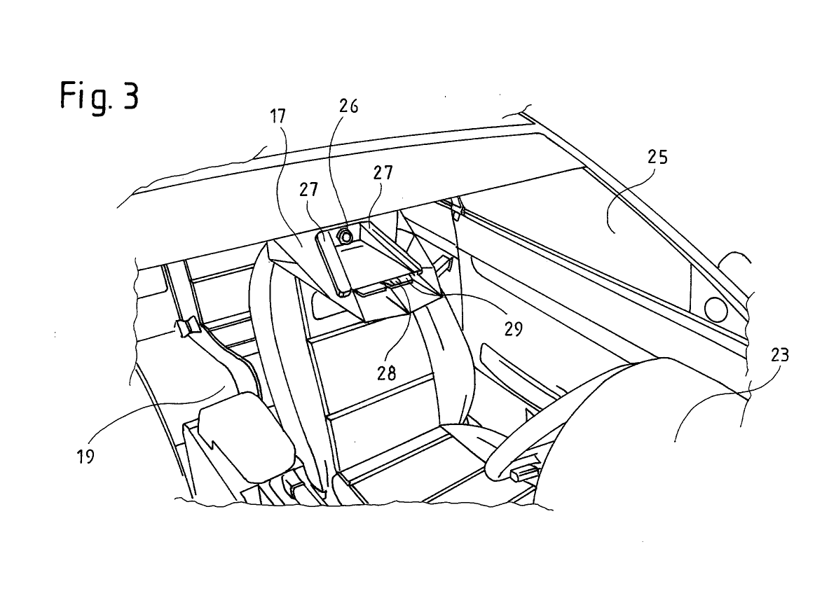

FIG. 3 shows those sensors of the device according to the invention, which face the window inside surface 25 of the windscreen of a vehicle. A solar radiation sensor 28 and a temperature sensor 29 for determining the temperature at the windscreen 25 are arranged in the area of the front camera 26 and the rain sensors 27. The solar radiation sensor 28 supplies measurements of the solar radiation entering the vehicle interior space 19.

1. A method for determining at least one control signal for controlling an air conditioning system for an interior space, in particular for an interior space of a vehicle in dependence of measured state variables of the interior climate wherein:
an interior climate value describing the interior climate is calculated from measurements of the interior temperature and from measurements of the interior air humidity by a signal-processing function;
an air quality value describing the air quality is calculated from measurements of the percentage of volatile organic compounds in the internal atmosphere by a signal-processing function; and
a control signal for an air conditioning system is calculated from the interior climate value and the air quality value by at least one signal-processing function.

2. The method according to claim 1, wherein one measurement of the solar radiation is input into the calculation of the interior climate value.

3. The method according to claim 1, wherein a measurement describing the outside air and recorded by an outside air quality sensor is input into the calculation of the air quality value.

4. The method according to claim 1, wherein at least one interior climate value and at least one air quality value are input into the calculation of a comfort function and in that specified parameters describing the climatic comfort zone of humans are input into the comfort function and in that at least one output value of the comfort function is input into a control signal which is forwarded to a control unit of an air conditioning system.

5. The method according to claim 1, wherein the air quality value and the interior climate value are input into an energy demand control model for minimising the energy demand of the air conditioning system, and in that at least one output value of the energy demand control model is input into a control signal, which is forwarded to a control unit of an air conditioning system.

6. The method according to claim 4, wherein output values of the comfort function and the output values of the energy demand control model are set into a relationship and in that for certain relationships of the output values a control signal is sent to the control unit of the air conditioning system for venting the interior space.

7. The method according to claim 1, wherein at least one temperature measurement at a surface in the interior space, in particular the inside surface of a window pane, and at least one measurement of the interior air humidity are input into a signal-processing function for determining the condensation probability of water in the interior space and in that the output values of the function are input into a control signal of an air conditioning system.

8. The method according to claim 1, wherein the measurements of the interior temperature are recorded in spatial dependence and in that conclusions are drawn from the spatially dependent measurements as to the number of persons present in the interior space, in particular as to a seat occupancy in a vehicle.

9. The method according to claim 8, wherein the number of persons present in the interior space is input into a control signal, which is forwarded to the control unit of an air conditioning system.

10. The method according to claim 8, wherein conclusions are drawn from the spatially dependent measurements of the interior temperature as to the size of a person sitting on a seat.

11. A device for performing the method according to claim 1, with at least one internal temperature sensor, at least one air humidity sensor and at least one air quality sensor for determining the percentage of volatile organic compounds in the internal atmosphere, characterised in that the sensors are connected in the signal-transferring manner with at least one computer unit for calculating a control signal on the basis of the output values of the sensors and in that the computer unit is connected in a signal-transferring manner with at least one control unit of an air conditioning system.

12. The device according to claim 11, wherein at least two sensors are installed in one assembly.

13. The device according to claim 11, wherein the device comprises a temperature sensor for determining the temperature at a surface, in particular a window inside surface of the interior space.

14. The device according to claim 11, wherein the device comprises a signal-transferring connection to an outside air quality sensor.

15. The device according to claim 11, wherein at least one internal temperature sensor faces the interior space, in particular faces the seats in a vehicle, and in that the internal temperature sensor comprises at least one thermopile.

16. A vehicle, in particular a motor vehicle with a device according to claim 11.
